(19) United States
(12) Patent Application Publication
(10) Pub. No.: US 2002/0094404 A1
(43) Pub. Date: Jul. 18, 2002

(54) Liner

(76) Inventor: Herbert S. Schottenfeld, Amelia Island, FL (US)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 09/759,687

(22) Filed: Jan. 12, 2001

(51) Int. Cl. B32B 5/18

(52) U.S. Cl. 428/41.8; 428/317.1; 428/317.3; 428/317.7; 428/198; 442/30; 156/77; 156/291

(57) ABSTRACT

A laminated liner for covering a generally smooth surface. The liner includes a foam pad having opposite first and second faces, and a sheet covering permanently bonded to the pad first face. An adhesive is applied to the pad second face for adhesively attaching the liner to the surface.

### BACKGROUND OF THE INVENTION

This invention relates generally to a padded decorative liner having an adhesive for attaching the liner to a surface.

In the past, various liners have been made for covering surfaces to protect the surfaces and improve their appearance. One such liner is a padded non-slip liner as described in U.S. Pat. No. 5,707,903, issued on Jan. 13, 1998, which is hereby incorporated by reference. That liner includes a sheet covering bonded to a pad made from a polyvinyl coated scrim. The sheet covering of the liner may be decorated to improve its appearance. Further, the pad of the liner provides cushioning to protect the surface and to protect articles falling on the liner. However, the liner cannot be applied to a vertical surface such as a wall behind a counter.

Another type of liner is commonly referred to as shelf paper even though it may be used on surfaces other than shelves and may be made of thin materials other than paper. For example, the shelf paper may be used to line drawers and may be made of vinyl sheet rather than paper. Frequently, the shelf paper is decorated on one side with a solid color or a design, and an adhesive is applied to the other side of the paper so that the paper may be attached to a surface. Although the shelf paper could be applied to vertical surfaces, it offers very limited protection for preventing damage to the surface or to articles falling on it.

### SUMMARY OF THE INVENTION

Among the several objects of this invention may be noted the provision of a liner having an adhesive permitting use on vertical surfaces; the provision of such a liner having a decorative side; and the provision of such a liner which is padded.

Briefly, the laminated liner of this invention comprises a foam pad having opposite first and second faces, and a sheet covering permanently bonded to the pad first face. An adhesive is applied to the pad second face for adhesively attaching the liner to the surface.

In another aspect, the present invention includes a method of making a liner comprising the steps of applying an adhesive to at least one of a covered padding and a release layer, and pressing the padding and the release layer together so that the adhesive releasably joins the release layer and the padding.

Other objects and features of this invention will be in part apparent and in part pointed out hereinafter.

### BRIEF DESCRIPTION OF THE DRAWINGS

FIG. 1 is a fragmentary bottom plan of a first preferred embodiment of a liner of the present invention partially broken away to show interior features;

FIG. 2 is a fragmentary top plan of the liner;

FIG. 3 is a cross section of the liner taken in the plane of line 3-3 of FIG. 1;

FIG. 4 is a fragmentary plan of a non-slip pad of a first preferred embodiment;

FIG. 5 is a fragmentary plan of the non-slip pad of a second embodiment of the liner;

FIG. 6 is a fragmentary plan of the non-slip pad of a third embodiment of the liner;

FIG. 7 is a fragmentary plan of the non-slip pad of a fourth embodiment of the liner;

FIG. 8 is a schematic showing a process for making the liner of the present invention; and

FIG. 9 is a cross section of the liner attached to a vertical surface.

Corresponding parts are designated by corresponding reference characters throughout the several views of the drawings.

### DETAILED DESCRIPTION OF THE PREFERRED EMBODIMENT

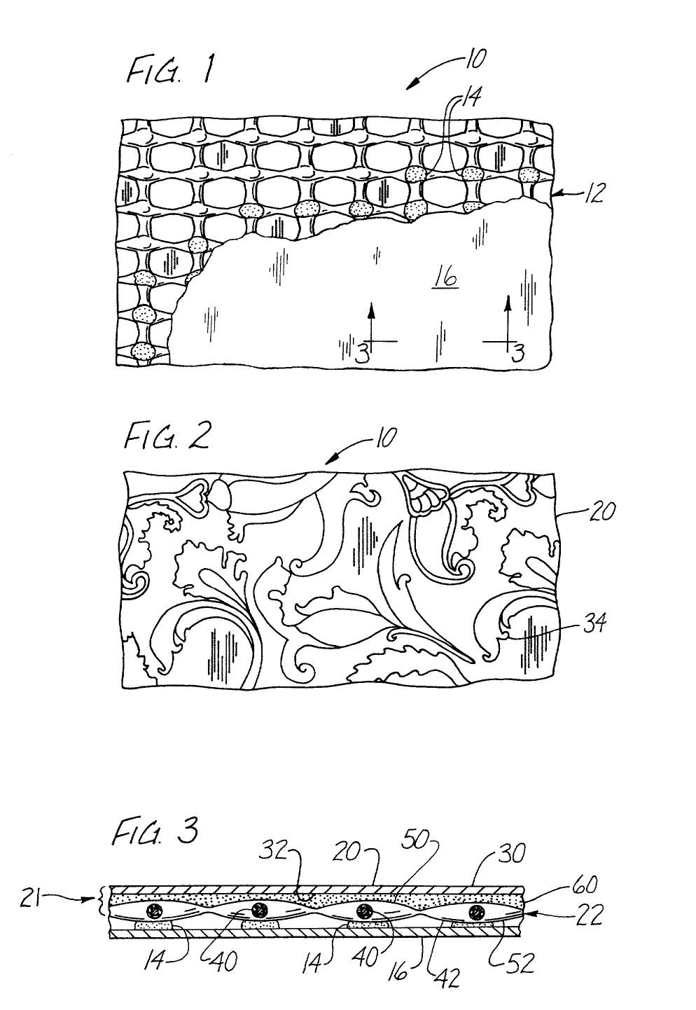

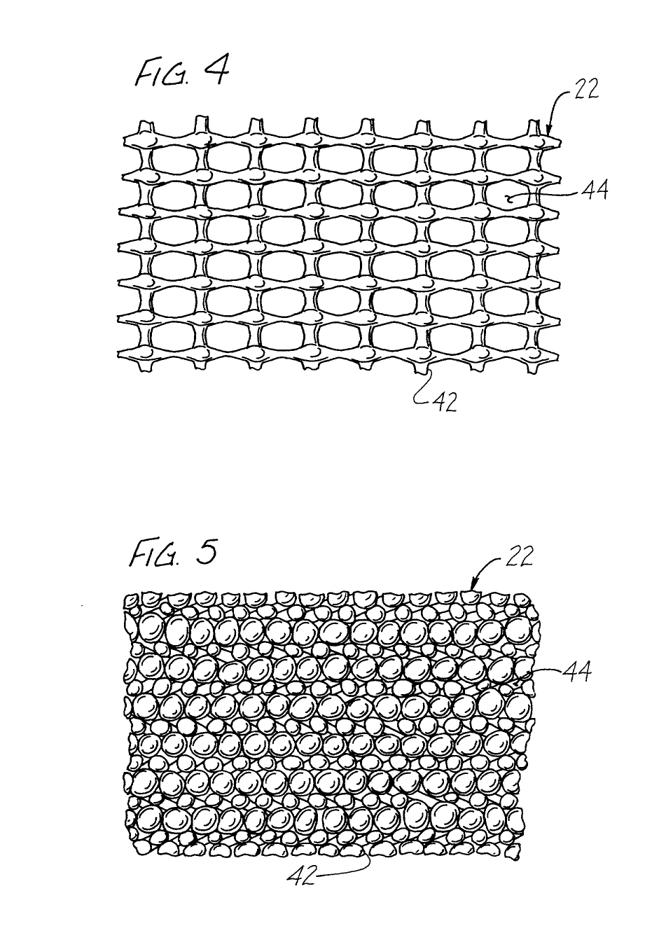

Referring now to the drawings, and first more particularly to FIGS. 1 and 2, a flexible, laminated liner incorporating the present invention is generally indicated by the reference numeral 10. As shown in FIG. 3, the liner 10 comprises a covered padding, generally designated by 12, having an adhesive 14 applied to the padding for adhesively attaching the liner to a surface S (FIG. 9). In one embodiment, the adhesive 14 used to attach the liner 10 to the surface S is covered with a removable release layer 16 to prevent the liner from being unintentionally attached to something before it is positioning on the surface. Further, in one embodiment the covered padding 12 is formed from a sheet covering 20 bonded to a pad, generally designated by 22.

The sheet covering 20 may be made of any sheet material such as paper, cloth, polyethylene or PVC sheet, or it may be made of a combination of these materials. Regardless of the composition of the covering 20, it is a generally continuous sheet material having opposite sides 30, 32. Although the sheet material is flexible in one embodiment, rigid material may be used in other embodiments. The material may incorporate a decorative marking or design 34 (FIG. 2) on the side 30 opposite the pad 22. The design 34 may include a paisley print as shown or it may include stripes, plaids, floral prints or other designs. Alternatively, the sheet material may be solidly colored (including white and black) throughout from the side 32 adjacent the pad 22 to the side 30 opposite it.

In one embodiment, the pad 22 is of the type formed from a scrim 40 coated with a polyvinyl chloride (PVC) foam 42. The scrim 40 is made of natural or synthetic fibers which are either knitted or woven into a network having intermittent openings spaced along the surface of the scrim. The openings are uniformly spaced along the scrim 40 in a repeating pattern. In a second embodiment (FIG. 5), the openings may be randomly spaced. Further, the scrim network openings may be rectangular as shown or they may be other shapes, including diamonds, triangles, octagons or combinations of the these shapes.

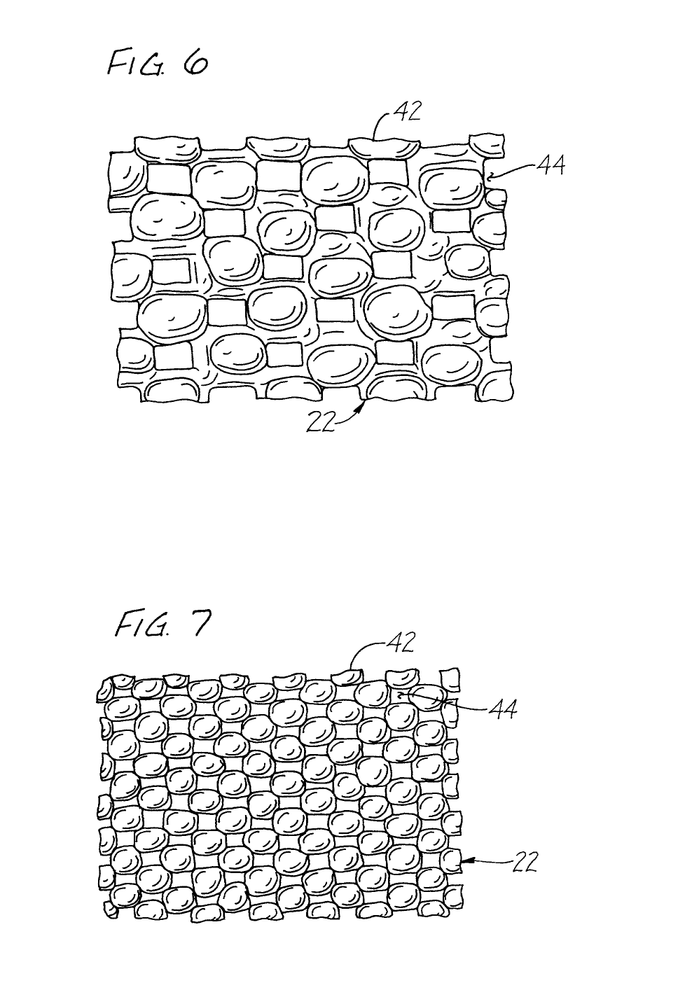

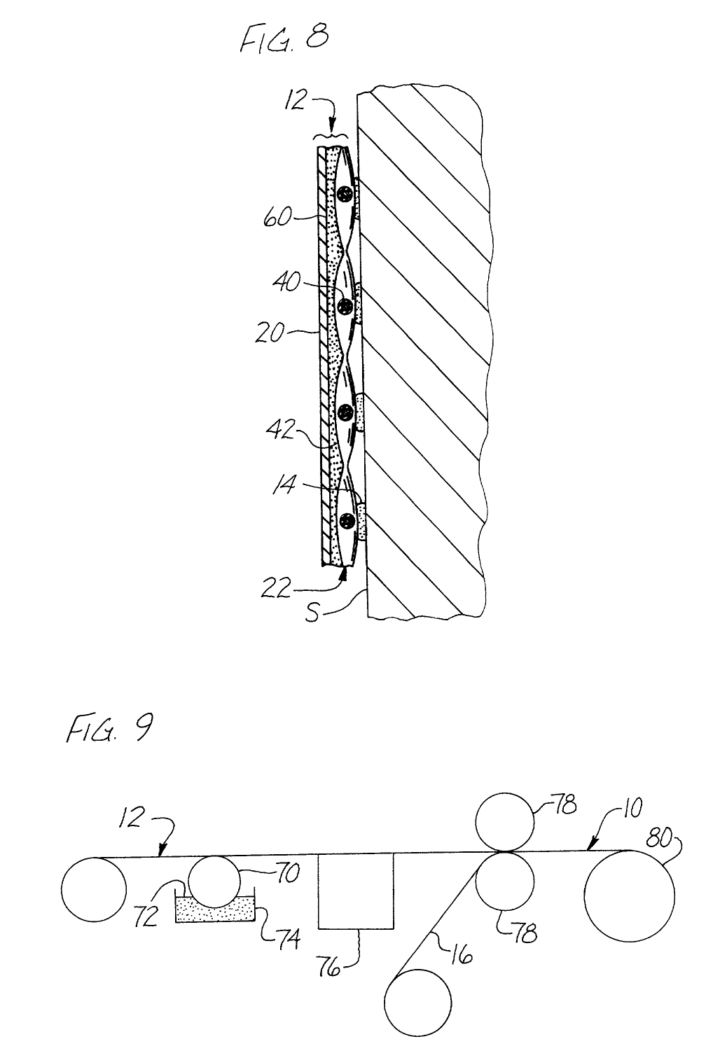

The pad 22 is formed by dipping the scrim 40 in liquid PVC and curing the dipped scrim in an oven. While being cured, a chemical reaction causes gas to be entrained in the PVC as it solidifies thereby causing voids in the PVC. When the PVC solidifies entirely, voids remain in the PVC to produce a soft, resilient, elastomeric, foam material. The resulting flexible pad 22 has generally uniform open cells 44 corresponding to the openings in the scrim 40. However, because the PVC increases in volume as it cures, the open cells 44 of the pad 22 are smaller than the openings in the scrim 40 and the thickness of the pad is greater than the scrim. The pad 22 has opposite faces 50, 52. In one embodiment, the open cells 44 extend entirely through the pad from the face 50 which is bonded to the sheet covering 20 to the face 52 opposite the sheet covering. Different colors of PVC (including black and white) may be used to make different colored pads 22. Pads 22 of this type are well-known in the art and will not be described in further detail. Although similar pads 22 are sold under many different trademarks, pads used in the preferred embodiments are sold by Griptex, Industries Inc. of Calhoun, Ga., under the trademarks, OMNI-GRIP, MAXI-GRIP, ULTRAGRIP, AIRE-GRIP and LOC-GRIP. An OMNI-GRIP pad 22 is shown in FIG. 4. MAXI-GRIP, ULTRA-GRIP and AIRE-GRIP pads 22 are shown as second through fourth embodiments in FIGS. 5-7, respectively. Each of these pads 22 is made with differently shaped scrims 40 using the process described above. Foam pads 22 produced by the process described above have several advantageous properties. The foam pads are light weight and low in cost. Further, the scrim used in the pads increases the tensile strength of the pads so that they are stronger than foamed PVC sheets without scrim.

Although the sheet covering 20 may be bonded to the pad 22 by other means without departing from the scope of the present invention, in one embodiment the covering is bonded to the pad with an adhesive layer 60. Numerous types of adhesives may used to form the adhesive layer 60 depending upon the materials employed in the pad 22 and sheet covering 20, the anticipated environment of the liner 10, and the desired characteristics of the product. These types of adhesives include water-based, latex-based, solvent-based and acrylic-based adhesives. Further, portions of the pad 22 or the sheet covering 20 may be melted or otherwise treated to generate the adhesive layer 60.

To manufacture the covered padding 12, the adhesive 60 is applied to either the pad 22, the sheet covering 20 or both before the pad and covering are brought into contact. Once assembled, the adhesive 60 may require time to cure. If desired, the padding 12 temperature may be elevated during the curing step to shorten the adhesive curing time. Although the decorative features of the sheet covering 20 are applied prior to assembly in the preferred embodiment, the features may be applied to the covering after assembly in another embodiment. Covered padding 12 of the type described above is conventional and will not be described in further detail. Although covered padding 12 having other configurations may be used without departing from the scope of the present invention, covered padding used in the embodiments described herein are sold by Griptex, Industries Inc. of Calhoun, Ga.

Although other adhesives including permanent adhesives and release adhesive may be used without departing from the scope of the present invention, in one embodiment the adhesive 14 used to attach the liner 10 to the surface S is a pressure sensitive acrylic adhesive. Although other acrylic adhesives may be used without departing from the scope of the present invention, in one embodiment the adhesive is FLEXBOND® 153 adhesive available from Air Products and Chemicals, Inc. of Allentown, Pa. FLEXBOND is a U.S. federally registered trademark of Air Products and Chemicals, Inc. A desirable property of the FLEXBOND 153 adhesive is resistance to vinyl plasticizers so the foam 42 used in the padding 12 does not reduce the effectiveness of the adhesive. In one embodiment, the adhesive 14 is discontinuously applied to the pad 22 in spaced apart spots as illustrated in FIG. 1. However, it is envisioned the adhesive 14 may be formed as a continuous layer without departing from the scope of the present invention. Although other materials may be used to form the release layer 16 without departing from the scope of the present invention, in one embodiment the layer is a low density polyethylene film having a thickness of between about 0.002 and about 0.004 inches.

FIG. 8 schematically illustrates a method of manufacturing the liner 10 of the present invention. Covered padding 12 is pulled over an adhesive transfer roller 70 at a preselected speed. The adhesive transfer roller 70 picks up liquid adhesive 72 from a supply tank 74 and transfers the liquid adhesive to the face 52 of the covered padding 12 facing the roller to form the adhesive 14. Although the adhesive 14 may be transferred to the padding 12 in other ways without departing from the scope of the present invention, in one embodiment the adhesive is applied to the padding only intermittently (as shown in FIGS. 1 and 3) and only to a maximum thickness of about 0.001 inches. After the adhesive 14 is applied to the padding 12, it is dried. Although other drying methods may be used without departing from the scope of the present invention, in one embodiment the adhesive 14 is dried on a steam barrel 76 at about 200 degrees Fahrenheit for between about one minute and about two minutes. Release material 16 is pressed against the dried adhesive 14 between pinch rollers 78. The finished liner 10 may be rolled onto a take-up spool 80 for further processing.

The finished liner 10 may be rolled on a tube for shipment or it may be shipped as standard size flat sheets. Either shipment configuration allows the consumer to cut the liner 10 to any size for use. Once cut to size, the release material 16 is removed from the liner 10 and the exposed adhesive 14 is pressed into position against the surface S as shown in FIG. 9. Because the liner 10 includes the adhesive 14, it can me mounted on both vertical and horizontal surfaces to improve their appearance and protect them from damage.

In contrast to most prior art shelf papers, the liner 10 of the present invention includes a foamed PVC pad 22 which provides cushioning to prevent damage to articles contacting the liner and to prevent damage to surfaces covered by the liner. The liner 10 is also thicker than prior art shelf papers so that the articles are less likely to penetrate the product and damage the surface S. In addition, the foam dampens vibration so that articles having uneven bases are less likely to vibrate and rattle against the surface S and against one another with the liner 10 than with prior art shelf papers.

In view of the above, it will be seen that the several objects of the invention are achieved and other advantageous results attained.

When introducing elements of the present invention or the preferred embodiments) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

What is claimed is:

1. A laminated liner for covering a generally smooth surface, the liner comprising:
a foam pad having opposite first and second faces;
a covering permanently bonded to said pad first face; and
an adhesive applied to said pad second face for adhesively attaching the liner to the surface.

2. A liner as set forth in claim 1 wherein the pad comprises a foamed polyvinyl chloride coated scrim

3. A liner as set forth in claim 2 wherein the pad has a plurality of open cells extending through the pad from said first face to said second face.

4. A liner as set forth in claim 1 wherein the covering is substantially continuous.

5. A liner as set forth in claim 1 wherein the adhesive is a releasable adhesive.

6. A liner as set forth in claim 5 wherein the adhesive is a pressure sensitive acrylic adhesive.

7. A liner as set forth in claim 5 further comprising removable release layer applied to the adhesive for preventing the liner from being unintentionally attached prior to positioning on the surface.

8. A liner as set forth in claim 7 wherein the release layer is a low density polyethylene film.

9. A liner as set forth in claim 1 wherein the adhesive is a permanent adhesive.

10. A liner as set forth in claim 1 wherein said covering includes a decorative marking thereon.

11. A liner as set forth in claim 1 wherein said adhesive is discontinuously applied to said pad in spaced apart spots.

12. A method of making a liner comprising the steps of applying an adhesive to at least one of a covered padding and a release layer, and pressing the padding and the release layer together so that the adhesive releasably joins the release layer and the padding.

13. A method of making a liner as set forth in claim 12 further comprising the step of drying the adhesive prior to pressing the padding and the release layer together.

14. A method of making a liner as set forth in claim 12 wherein the adhesive is applied to the covered padding.

15. A method of making a liner as set forth in claim 12 wherein the adhesive is applied using a roller.

16. A method of making a liner as set forth in claim 12 wherein the adhesive is discontinuously applied to said padding in spaced apart spots.
